(19) United States
(12) Patent Application Publication
(10) Pub. No.: US 2023/0299436 A1
(43) Pub. Date: Sep. 21, 2023

(54) SECONDARY BATTERY, ELECTRONIC EQUIPMENT, AND ELECTRIC TOOL

(71) Applicant: MURATA MANUFACTURING CO., LTD., Kyoto (JP)

(72) Inventor: Satoru TANAKA, Kyoto (JP)

(21) Appl. No.: 18/203,505

(22) Filed: May 30, 2023

Related U.S. Application Data
(63) Continuation of application No. PCT/JP2021/040358, filed on Nov. 2, 2021.

(30) Foreign Application Priority Data
Jan. 18, 2021 (JP) 2021-005447

(51) Int. Cl. H01M 50/538; H01M 50/107; H01M 10/0525; H01M 10/0587

(52) U.S. Cl. CPC H01M 50/538; H01M 50/107; H01M 10/0525; H01M 10/0587

(57) ABSTRACT

A battery for high-rate discharging is provided that achieves a further increased battery capacity and is free from an internal short circuit. A negative electrode includes, on a negative electrode foil having a band shape, a negative electrode active material covered part covered with a negative electrode active material layer, a first negative electrode active material uncovered part extending in a longitudinal direction of the negative electrode foil, a second negative electrode active material uncovered part provided at an end part in the longitudinal direction on a beginning side of winding, and an insulating resin part provided between the negative electrode active material covered part and the first negative electrode active material uncovered part. A positive electrode active material uncovered part is coupled to a positive electrode current collector at one of end parts of an electrode wound body. The first negative electrode active material uncovered part is coupled to a negative electrode current collector at another of the end parts of the electrode wound body. The electrode wound body has one or more flat surfaces, in which the positive electrode active material uncovered part, the first negative electrode active material uncovered part, or both are bent toward a central axis of a wound structure to form the one or more flat surfaces, and a groove provided in each of the one or more flat surfaces.

### CROSS REFERENCE TO RELATED APPLICATIONS

The present application is a continuation of PCT patent application no. PCT/JP2021/040358, filed on Nov. 2, 2021, which claims priority to Japanese patent application no. JP2021-005447, filed on Jan. 18, 2021, the entire contents of which are incorporated herein by reference.

### BACKGROUND

The present application relates to a secondary battery, electronic equipment, and an electric tool.

Development of lithium ion batteries has expanded to applications that require high output power, including electric tools and vehicles. One of methods to achieve high output power is high-rate discharging in which a relatively large current is fed from a battery. Because the high-rate discharging involves feeding of a large current, it is desirable to reduce an internal resistance of the battery.

For example, a first type of secondary battery is described in which an active material mixture layer is provided in a width direction of a negative electrode.

Further, a second type of secondary battery is described in which a negative electrode is cut at a beginning and an end of a region where an active material mixture layer is provided.

### SUMMARY

The present application relates to a secondary battery, electronic equipment, and an electric tool.

A technique described in the Background regarding the first type of secondary battery does not consider variations in dimension of an active material mixture layer in a width direction of a negative electrode. Accordingly, it is necessary that a region of an active material mixture layer of a positive electrode be so adjusted as to cause the active material mixture layer of the positive electrode to be reliably opposed to the active material mixture layer of the negative electrode. This can result in a disadvantage in that the region of the active material mixture layer of the positive electrode becomes smaller, and a battery capacity becomes lower, accordingly. A battery described in the Background regarding the second type of secondary battery has a disadvantage in that, when a current collector is pressed against an end part of an electrode wound body, a negative electrode active material can peel and fall off an active material covered part of a negative electrode, and an internal short circuit is caused by the active material having fallen off.

The present application relates to providing a battery to be used in high-rate discharging, the battery achieving an increased battery capacity and being free from occurrence of an internal short circuit according to an embodiment.

The present application, in an embodiment, provides a secondary battery including an electrode wound body, a positive electrode current collector, a negative electrode current collector, and a battery can. The electrode wound body includes a positive electrode having a band shape and a negative electrode having a band shape. The positive electrode and the negative electrode are stacked with a separator interposed therebetween. The battery can contains the electrode wound body, the positive electrode current collector, and the negative electrode current collector.

The positive electrode includes, on a positive electrode foil having a band shape, a positive electrode active material covered part covered with a positive electrode active material layer, and a positive electrode active material uncovered part.

The negative electrode includes, on a negative electrode foil having a band shape, a negative electrode active material covered part covered with a negative electrode active material layer, a first negative electrode active material uncovered part extending in a longitudinal direction of the negative electrode foil, a second negative electrode active material uncovered part provided at an end part in the longitudinal direction on a beginning side of winding, and an insulating resin part provided between the negative electrode active material covered part and the first negative electrode active material uncovered part.

The positive electrode active material uncovered part is coupled to the positive electrode current collector at one of end parts of the electrode wound body.

The first negative electrode active material uncovered part is coupled to the negative electrode current collector at another of the end parts of the electrode wound body.

The electrode wound body has one or more flat surfaces, in which the positive electrode active material uncovered part, the first negative electrode active material uncovered part, or both are bent toward a central axis of the wound structure to form the one or more flat surfaces, and a groove provided in each of the one or more flat surfaces.

According to an embodiment, it is possible to provide a battery to be used in high-rate discharging, the battery being free from occurrence of an internal short circuit and being increased in battery capacity. It should be understood that the contents of the present application are not to be construed as being limited by the effects exemplified herein.

### BRIEF DESCRIPTION OF THE FIGURES

FIG. 1 includes views A and B which are diagrams to be referred to in describing an issue to be considered in the present application.

FIG. 2 is a sectional view of a lithium ion battery according to an embodiment.

FIG. 3 includes views A and B, where view A is a plan view of a positive electrode current collector according to an embodiment, and view B is a plan view of a negative electrode current collector according to an embodiment.

FIG. 4 includes views A and B which are diagrams to be referred to in describing a negative electrode according to an embodiment.

FIG. 5 is a diagram illustrating a positive electrode, the negative electrode, and a separator before being wound.

FIG. 6 includes views A to F which are diagrams describing a process of assembling the lithium ion battery according to an embodiment.

FIG. 7 includes views A and B which are diagrams for describing Comparative example 1.

FIG. 8 includes views A and B which are diagrams for describing Comparative example 2.

FIG. 9 includes views A and B which are diagrams for describing Comparative example 3.

FIG. 10 is a coupling diagram for use to describe a battery pack as an application example according to an embodiment.

FIG. 11 is a coupling diagram for use to describe an electric tool as an application example according to an embodiment.

FIG. 12 is a coupling diagram for use to describe an electric vehicle as an application example according to an embodiment.

### DETAILED DESCRIPTION

One or more embodiments of the present application are described below in further detail including with reference to the drawings.

The one or more embodiments described herein are examples of the present application, and the contents of the present application are not limited thereto. It is to be noted that in order to facilitate understanding of description, some components in any of the drawings may be enlarged or reduced, or illustration of some portions may be simplified.

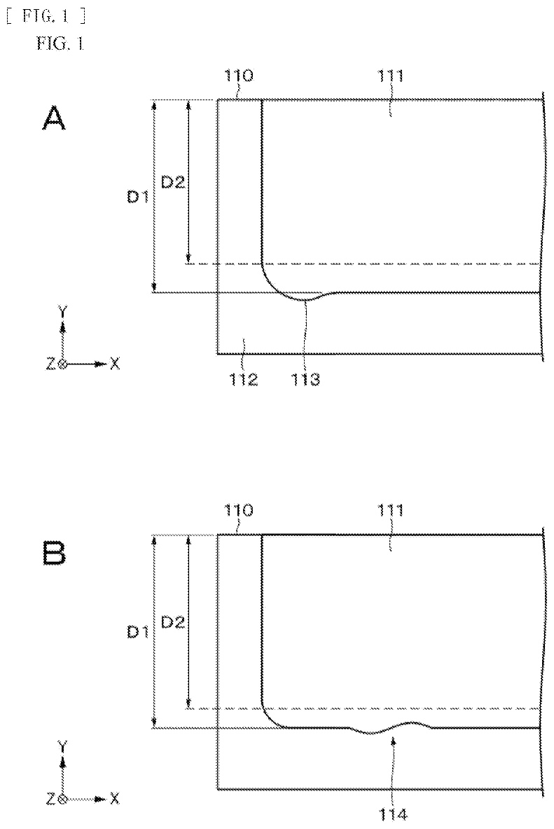

First, to facilitate understanding, one of issues to be considered in an embodiment will be described with reference to FIGS. 1A and 1B. Reference numeral 110 in FIGS. 1A and 1B denotes a negative electrode foil. Reference numeral 111 denotes a negative electrode active material covered part which is a negative electrode active material provided on the negative electrode foil 110. Reference numeral 112 denotes a negative electrode active material uncovered part which is a part of the negative electrode foil 110 not covered with the negative electrode active material. Note that in descriptions with reference to a positive electrode and a negative electrode before being wound, a winding direction of the negative electrode and the positive electrode, i.e., an X-axis direction in FIGS. 1A and 1B, may be referred to as a longitudinal direction, a direction orthogonal to the longitudinal direction, i.e., a Y-axis direction in FIGS. 1A and 1B, may be referred to as a width direction, and a Z-axis direction may be referred to as a thickness.

Typically, the negative electrode active material covered part 111 is provided by a method called intermittent coating. In the intermittent coating, the negative electrode active material is ejected and applied, thereafter, ejection is stopped, and thereafter, the negative electrode active material is ejected and applied again. Due to an increased pressure at the time of ejection of the negative electrode active material, an end part of the negative electrode active material covered part 111 can partly expand as indicated by reference numeral 113 in FIG. 1A. Further, because the negative electrode active material typically has fluidity, unevenness can develop at the end part of the negative electrode active material covered part 111, as indicated by reference numeral 114 in FIG. 1B. Such issues can similarly occur also in a case of providing the negative electrode active material covered part 111 by continuous coating. The development of such expansion, necking, or unevenness at the end part of the negative electrode active material covered part 111 results in variations in length D1 of the negative electrode active material covered part 111 in the width direction. In order to cause an unillustrated positive electrode active material covered part to be reliably opposed to the negative electrode active material covered part 111 in consideration of the above-described variations in the length D1, it is necessary to reduce a length D2, which is a length of the positive electrode active material covered part in the width direction. This can result in a disadvantage in that a region of the positive electrode active material covered part becomes smaller, and the battery capacity becomes lower, accordingly. Based upon the above-described perspective, an embodiment of the present application will be described in detail.

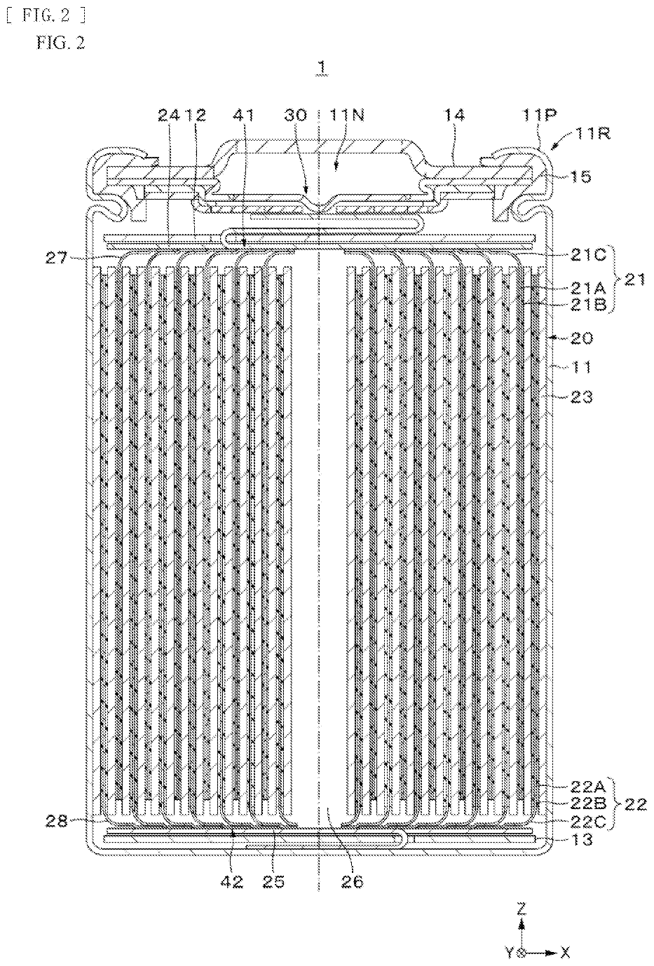

In an embodiment, a lithium ion battery having a cylindrical shape will be described as an example of a secondary battery. First, an overall configuration of the lithium ion battery will be described. FIG. 2 is a schematic sectional view of a lithium ion battery 1. As illustrated in FIG. 2, the lithium ion battery 1 has a cylindrical shape and includes an electrode wound body 20 contained inside a battery can 11, for example.

In a schematic configuration, the lithium ion battery 1 includes the battery can 11 having a cylindrical shape, and also includes, inside the battery can 11, a pair of insulators 12 and 13 and the electrode wound body 20. Note that the lithium ion battery 1 may further include, for example, one or more of devices and members including, without limitation, a thermosensitive resistive device or a PTC device and a reinforcing member, inside the battery can 11.

The battery can 11 is a member that contains mainly the electrode wound body 20. The battery can 11 is, for example, a cylindrical container with one end face open and another end face closed. That is, the battery can 11 has one open end face (an open end face 11N). The battery can 11 includes, for example, one or more of metal materials including, without limitation, iron, aluminum, and alloys thereof. The battery can 11 may have a surface plated with one or more of metal materials including, without limitation, nickel, for example.

The insulators 12 and 13 are dish-shaped plates each having a surface that is substantially perpendicular to a winding axis of the electrode wound body 20. The winding axis passes through substantially a center of an end face of the electrode wound body 20 and is in a direction parallel to a Z-axis in FIG. 2. The insulators 12 and 13 are so disposed as to allow the electrode wound body 20 to be interposed therebetween, for example.

A battery cover 14 and a safety valve mechanism 30 are crimped to the open end face 11N of the battery can 11 via a gasket 15 to thereby provide a crimped structure 11R (a crimp structure). The battery can 11 is thus sealed, being in a state where the electrode wound body 20 and other components are contained inside the battery can 11.

The battery cover 14 is a member that closes the open end face 11N of the battery can 11 mainly in the state where the electrode wound body 20 and the other components are contained inside the battery can 11. The battery cover 14 includes, for example, a material similar to the material included in the battery can 11. A middle region of the battery cover 14 protrudes in a +Z direction, for example. A region other than the middle region, that is, a peripheral region, of the battery cover 14 is thus in contact with the safety valve mechanism 30, for example.

The gasket 15 is a member that is mainly interposed between the battery can 11 (a bent part 11P) and the battery cover 14 to thereby seal a gap between the bent part 11P and the battery cover 14. Note that the gasket 15 may have a surface coated with a material such as asphalt, for example.

The gasket 15 includes one or more of insulating materials, for example. The insulating material is not particularly limited in kind. For example, a polymer material such as polybutylene terephthalate (PBT) or polypropylene (PP) may be used as the insulating material. In particular, the insulating material is preferably polybutylene terephthalate. A reason for this is that such a material is able to sufficiently seal the gap between the bent part 11P and the battery cover 14 while electrically separating the battery can 11 and the battery cover 14 from each other.

The safety valve mechanism 30 cancels the sealed state of the battery can 11 and thereby releases a pressure inside the battery can 11, i.e., an internal pressure of the battery can 11 on an as-needed basis, mainly upon an increase in the internal pressure. Examples of a cause of the increase in the internal pressure of the battery can 11 include a gas generated due to a decomposition reaction of an electrolytic solution during charging and discharging.

In the lithium ion battery 1 having a cylindrical shape, a positive electrode 21 having a band shape and a negative electrode 22 having a band shape, which are stacked with a separator 23 interposed therebetween and are wound in a spiral shape, are contained in the battery can 11, being impregnated with the electrolytic solution. The positive electrode 21 includes a positive electrode foil 21A with a positive electrode active material layer 21B provided on one of or each of both surfaces of the positive electrode foil 21A. A material of the positive electrode foil 21A is a metal foil including, for example, aluminum or an aluminum alloy. The negative electrode 22 includes a negative electrode foil 22A with a negative electrode active material layer 22B provided on one of or each of both surfaces of the negative electrode foil 22A. A material of the negative electrode foil 22A is a metal foil including, for example, nickel, a nickel alloy, copper, or a copper alloy. The separator 23 is a porous insulating film. The separator 23 electrically insulates the positive electrode 21 and the negative electrode 22 from each other, and allows for movement of substances including, without limitation, ions and the electrolytic solution.

The positive electrode 21 includes a part covered with the positive electrode active material layer 21B at each of one major surface and another major surface of the positive electrode foil 21A, and also includes a part not covered with the positive electrode active material layer 21B. The negative electrode 22 includes a part covered with the negative electrode active material layer 22B at each of one major surface and another major surface of the negative electrode foil 22A, and also includes a part not covered with the negative electrode active material layer 22B. In the present specification, the part not covered with the positive electrode active material layer 21B will be referred to as a positive electrode active material uncovered part 21C, and the part not covered with the negative electrode active material layer 22B will be referred to as a negative electrode active material uncovered part 22C as appropriate. The part covered with the positive electrode active material layer 21B will be referred to as a positive electrode active material covered part 21B, and the part covered with the negative electrode active material layer 22B will be referred to as a negative electrode active material covered part 22B as appropriate. In the electrode wound body 20 of the cylindrical battery, the positive electrode 21 and the negative electrode 22 are laid over each other and wound, with the separator 23 interposed therebetween, in such a manner that the positive electrode active material uncovered part 21C and the negative electrode active material uncovered part 22C face toward opposite directions.

The electrode wound body 20 has a through hole 26 in a region including a central axis of the electrode wound body 20. The through hole 26 is used as a hole into which a tool such as a welding tool is to be placed in a process of assembling the lithium ion battery 1.

In a typical lithium ion battery, for example, a lead for current extraction is welded at one location on each of the positive electrode and the negative electrode. However, such a configuration is not suitable for high-rate discharging because a high internal resistance of the battery results to cause the lithium ion battery to generate heat and become hot during discharging. To address this, in the lithium ion battery 1 according to the present embodiment, a positive electrode current collector 24 is disposed on one end face, i.e., an end face 41, of the electrode wound body 20, and a negative electrode current collector 25 is disposed on another end face, i.e., an end face 42, of the electrode wound body 20. In addition, the positive electrode current collector 24 and the positive electrode active material uncovered part 21C located at the end face 41 are welded to each other at multiple points; and the negative electrode current collector 25 and the negative electrode active material uncovered part 22C located at the end face 42 are welded to each other at multiple points. The internal resistance of the lithium ion battery 1 is thereby kept low to allow for high-rate discharging.

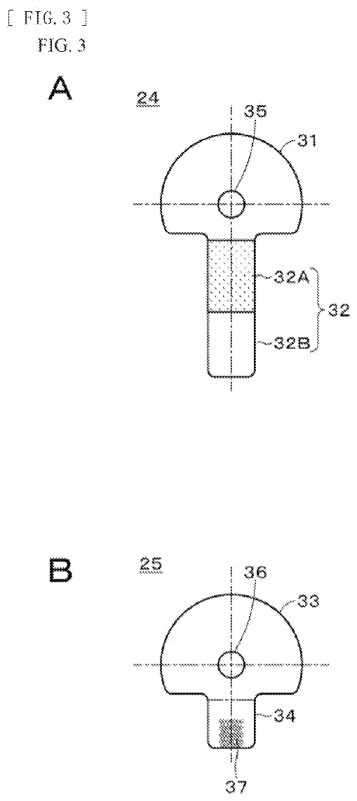

FIGS. 3A and 3B illustrate respective examples of the current collectors. FIG. 3A illustrates the positive electrode current collector 24. FIG. 3B illustrates the negative electrode current collector 25. The positive electrode current collector 24 and the negative electrode current collector 25 are contained in the battery can 11 (see FIG. 2). A material of the positive electrode current collector 24 is a metal plate including, for example, a simple substance or a composite material of aluminum or an aluminum alloy. A material of the negative electrode current collector 25 is a metal plate including, for example, a simple substance or a composite material of nickel, a nickel alloy, copper, or a copper alloy. As illustrated in FIG. 3A, the positive electrode current collector 24 has a shape in which a band-shaped part 32 having a rectangular shape is attached to a fan-shaped part 31 having a flat fan shape. The fan-shaped part 31 has a hole 35 at a position near a middle thereof. The position of the hole 35 corresponds to a position of the through hole 26.

A part shaded with dots in FIG. 3A represents an insulating part 32A in which an insulating tape or an insulating material is attached or applied to the band-shaped part 32. A part below the dot-shaded part in FIG. 3A represents a coupling part 32B to be coupled to a sealing plate that also serves as an external terminal. Note that in a case of a battery structure having no metallic center pin (not illustrated) in the through hole 26, the insulating part 32A may be omitted because there is a low possibility of contact of the band-shaped part 32 with a region of a negative electrode potential. In such a case, it is possible to increase charge and discharge capacities by increasing a width of each of the positive electrode 21 and the negative electrode 22 by an amount corresponding to a thickness of the insulating part 32A.

The negative electrode current collector 25 is similar to the positive electrode current collector 24 in shape, but has a band-shaped part of a different shape. The band-shaped part 34 of the negative electrode current collector of FIG. 3B is shorter than the band-shaped part 32 of the positive electrode current collector and includes no portion corresponding to the insulating part 32A. The band-shaped part 34 is provided with circular projections 37 depicted as multiple circles. Upon resistance welding, current is concentrated on the projections 37, causing the projections 37 to melt to thereby cause the band-shaped part 34 to be welded to a bottom of the battery can 11. As with the positive electrode current collector 24, the negative electrode current collector 25 has a hole 36 at a position near a middle of a fan-shaped part 33. The position of the hole 36 corresponds to the position of the through hole 26. The fan-shaped part 31 of the positive electrode current collector 24 and the fan-shaped part 33 of the negative electrode current collector 25, which are each in the shape of a fan, cover respective portions of the end faces 41 and 42. By not covering all of the respective end faces 41 and 42, it is possible to allow the electrolytic solution to smoothly permeate the electrode wound body 20 in assembling the lithium ion battery 1, and it is also possible to facilitate releasing of a gas, which is generated when the lithium ion battery 1 comes into an abnormally hot state or an overcharged state, to the outside of the lithium ion battery 1.

The positive electrode active material layer 21B includes at least a positive electrode material (a positive electrode active material) into which lithium is insertable and from which lithium is extractable, and may further include, for example, a positive electrode binder and a positive electrode conductor. The positive electrode material is preferably a lithium-containing composite oxide or a lithium-containing phosphoric acid compound. The lithium-containing composite oxide has a layered rock-salt crystal structure or a spinel crystal structure, for example. The lithium-containing phosphoric acid compound has an olivine crystal structure, for example.

The positive electrode binder includes a synthetic rubber or a polymer compound. Examples of the synthetic rubber include a styrene-butadiene-based rubber, a fluorine-based rubber, and ethylene propylene diene. Examples of the polymer compound include polyvinylidene difluoride (PVdF) and polyimide.

The positive electrode conductor is a carbon material such as graphite, carbon black, acetylene black, or Ketjen black. Note that the positive electrode conductor may be a metal material or an electrically conductive polymer.

The negative electrode foil 22A configuring the negative electrode 22 is preferably roughened at its surface to achieve improved adherence to the negative electrode active material layer 22B. The negative electrode active material layer 22B includes at least a negative electrode material (a negative electrode active material) into which lithium is insertable and from which lithium is extractable, and may further include, for example, a negative electrode binder and a negative electrode conductor.

The negative electrode material includes a carbon material, for example. The carbon material is graphitizable carbon, non-graphitizable carbon, graphite, low-crystalline carbon, or amorphous carbon. The carbon material has a fibrous shape, a spherical shape, a granular shape, or a flaky shape.

Further, the negative electrode material includes a metal-based material, for example. Examples of the metal-based material include Li (lithium), Si (silicon), Sn (tin), Al (aluminum), Zr (zinc), and Ti (titanium). A metallic element forms a compound, a mixture, or an alloy with another element, and examples thereof include silicon oxide (SiOx (0<x≤2)), silicon carbide (SiC), an alloy of carbon and silicon, and lithium titanium oxide (LTO).

The separator 23 is a porous film including a resin, and may be a stacked film including two or more kinds of porous films. Examples of the resin include polypropylene and polyethylene. With the porous film as a base layer, the separator 23 may include a resin layer provided on one of or each of both surfaces of the base layer. A reason for this is that this improves adherence of the separator 23 to each of the positive electrode 21 and the negative electrode 22 and thus suppresses distortion of the electrode wound body 20.

The resin layer includes a resin such as PVdF. In a case of forming the resin layer, a solution including an organic solvent and the resin dissolved therein is applied on the base layer, following which the base layer is dried. Note that the base layer may be immersed in the solution and thereafter the base layer may be dried. From the viewpoint of improving heat resistance and battery safety, the resin layer preferably includes inorganic particles or organic particles. Examples of the kind of the inorganic particles include aluminum oxide, aluminum nitride, aluminum hydroxide, magnesium hydroxide, boehmite, talc, silica, and mica. Alternatively, a surface layer including inorganic particles as a main component and formed by a method such as a sputtering method or an atomic layer deposition (ALD) method may be used instead of the resin layer.

The electrolytic solution includes a solvent and an electrolyte salt, and may further include other materials such as additives on an as-needed basis. The solvent is a nonaqueous solvent such as an organic solvent, or water. The electrolytic solution including a nonaqueous solvent is called a nonaqueous electrolytic solution. Examples of the nonaqueous solvent include a cyclic carbonic acid ester, a chain carbonic acid ester, a lactone, a chain carboxylic acid ester, and a nitrile (mononitrile).

Although a typical example of the electrolyte salt is a lithium salt, the electrolyte salt may include any salt other than the lithium salt. Examples of the lithium salt include lithium hexafluorophosphate (LiPF₆), lithium tetrafluoroborate (LiBF₄), lithium perchlorate (LiClO₄), lithium methanesulfonate (LiCH₃SO₃), lithium trifluoromethanesulfonate (LiCF₃SO₃), and dilithium hexafluorosilicate (Li₂SF₆). These salts may also be used in mixture with each other. From the viewpoint of improving a battery characteristic, it is preferable to use a mixture of LiPF₆ and LiBF₄, in particular. Although not particularly limited, a content of the electrolyte salt is preferably in a range from 0.3 mol/kg to 3 mol/kg both inclusive with respect to the solvent.

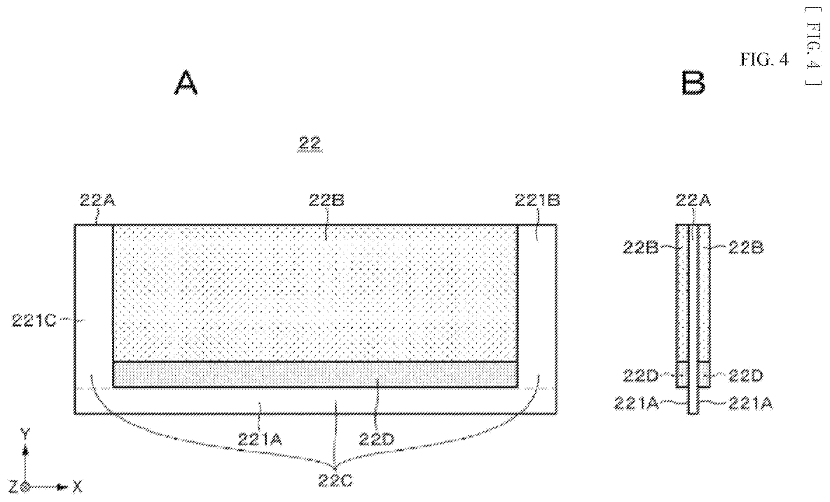

Next, the electrode wound body 20 and the negative electrode 22 will be described in further detail. FIG. 4A is a front view of the negative electrode 22 before being wound. FIG. 4B is a side view of the negative electrode 22 before being wound.

As illustrated in FIG. 4A, the negative electrode 22 according to the present embodiment includes the negative electrode active material covered part 22B provided on the negative electrode foil 22A having a band shape. The negative electrode active material covered part 22B is shaded with dots (a dot pattern). Further, the negative electrode 22 includes the negative electrode active material uncovered part 22C. The negative electrode active material uncovered part 22C includes, for example, a first negative electrode active material uncovered part 221A, a second negative electrode active material uncovered part 221B, and a third negative electrode active material uncovered part 221C. The first negative electrode active material uncovered part 221A extends in the longitudinal direction of the negative electrode foil 22A, i.e., in the X-axis direction. The second negative electrode active material uncovered part 221B is provided at an end part in the longitudinal direction on a beginning side of winding and extends in the width direction of the negative electrode foil 22A, i.e., in the Y-axis direction. The third negative electrode active material uncovered part 221C is provided at an end part in the longitudinal direction on an end side of the winding and extends in the width direction of the negative electrode foil 22A, i.e., in the Y-axis direction. Note that in FIG. 4A, a boundary between the first negative electrode active material uncovered part 221A and the second negative electrode active material uncovered part 221B, and a boundary between the first negative electrode active material uncovered part 221A and the third negative electrode active material uncovered part 221C are each represented by a dashed line.

Furthermore, an insulating resin part 22D is provided between the negative electrode active material covered part 22B and the first negative electrode active material uncovered part 221A. The insulating resin part 22D includes a resin such as PVdF. The insulating resin part 22D may further include inorganic particles or organic particles. Examples of the inorganic particles include particles of one or more of materials including, without limitation, aluminum oxide, aluminum nitride, aluminum hydroxide, magnesium hydroxide, boehmite, talc, silica, and mica.

As illustrated in FIG. 4B, in the present embodiment, both surfaces of the negative electrode foil 22A are each provided with the negative electrode active material covered part 22B and the insulating resin part 22D. The insulating resin part 22D has a thickness smaller than or equal to a thickness of the negative electrode active material covered part 22B. Note that the negative electrode 22 may have a configuration in which one of the major surfaces of the negative electrode foil 22A is provided with the negative electrode active material covered part 22B and the insulating resin part 22D.

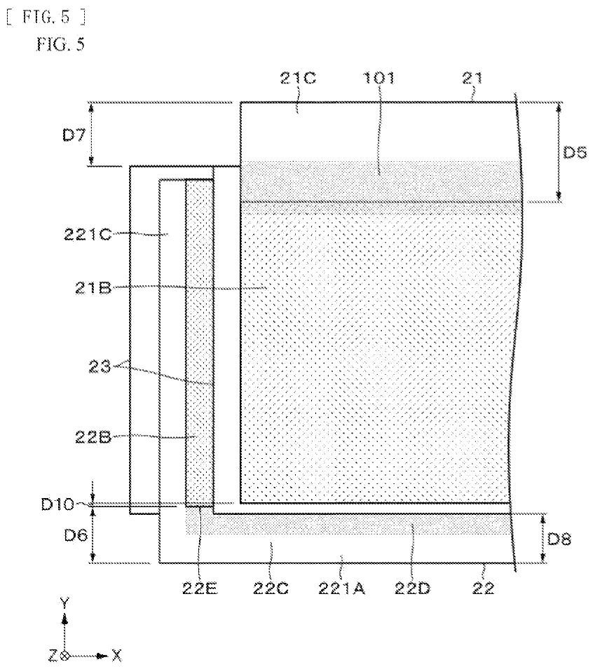

FIG. 5 illustrates an example of a pre-winding structure in which the positive electrode 21, the negative electrode 22, and the separator 23 are stacked. The positive electrode 21 includes an insulating layer 101 (a gray-region part in FIG. 5) covering a boundary between the positive electrode active material covered part 21B (a part lightly shaded with dots in FIG. 5) and the positive electrode active material uncovered part 21C. The insulating layer 101 has a length in the width direction of about 3 mm, for example. All of a region of the positive electrode active material uncovered part 21C opposed to the negative electrode active material covered part 22B with the separator 23 interposed therebetween is covered with the insulating layer 101. The insulating layer 101 has an effect of reliably preventing an internal short circuit of the lithium ion battery 1 when foreign matter enters between the negative electrode active material covered part 22B and the positive electrode active material uncovered part 21C. In addition, the insulating layer 101 has an effect of, in a case where the lithium ion battery 1 undergoes an impact, absorbing the impact and thereby reliably preventing the positive electrode active material uncovered part 21C from bending and short-circuiting with the negative electrode 22.

Here, as illustrated in FIG. 5, a length of the positive electrode active material uncovered part 21C in the width direction is denoted as D5, and a length of the first negative electrode active material uncovered part 221A and the insulating resin part 22D in the width direction is denoted as D6. In an embodiment, it is preferable that D5>D6. For example, D5=7 (mm), and D6=4 (mm). Where a length of a portion of the positive electrode active material uncovered part 21C protruding from one end in the width direction of the separator 23 is denoted as D7 and a length of a portion of the insulating resin part 22D and the first negative electrode active material uncovered part 221A protruding from another end in the width direction of the separator 23 is denoted as D8, in an embodiment, it is preferable that D7>D8. For example, D7=4.5 (mm), and D8=3 (mm).

The positive electrode foil 21A and the positive electrode active material uncovered part 21C include aluminum, for example. The negative electrode foil 22A and the negative electrode active material uncovered part 22C include copper, for example. Thus, the positive electrode active material uncovered part 21C is typically softer, that is, lower in Young's modulus, than the negative electrode active material uncovered part 22C. Accordingly, in an embodiment, it is more preferable that D5>D6 and D7>D8. In such a case, when portions of the positive electrode active material uncovered part 21C and portions of the negative electrode active material uncovered part 22C are simultaneously bent with equal pressures from both electrode sides, respective heights of the bent portions as measured from respective ends of the separator 23 may be substantially the same between the positive electrode 21 and the negative electrode 22. In this situation, the portions of the positive electrode active material uncovered part 21C appropriately overlap with each other when bent, which makes it possible to easily couple the positive electrode active material uncovered part 21C and the positive electrode current collector 24 to each other by laser welding in a process of fabricating the lithium ion battery 1. Further, the portions of the negative electrode active material uncovered part 22C appropriately overlap with each other when bent, which makes it possible to easily couple the negative electrode active material uncovered part 22C and the negative electrode current collector 25 to each other by laser welding in the process of fabricating the lithium ion battery 1. Details of the process of fabricating the lithium ion battery 1 will be described later.

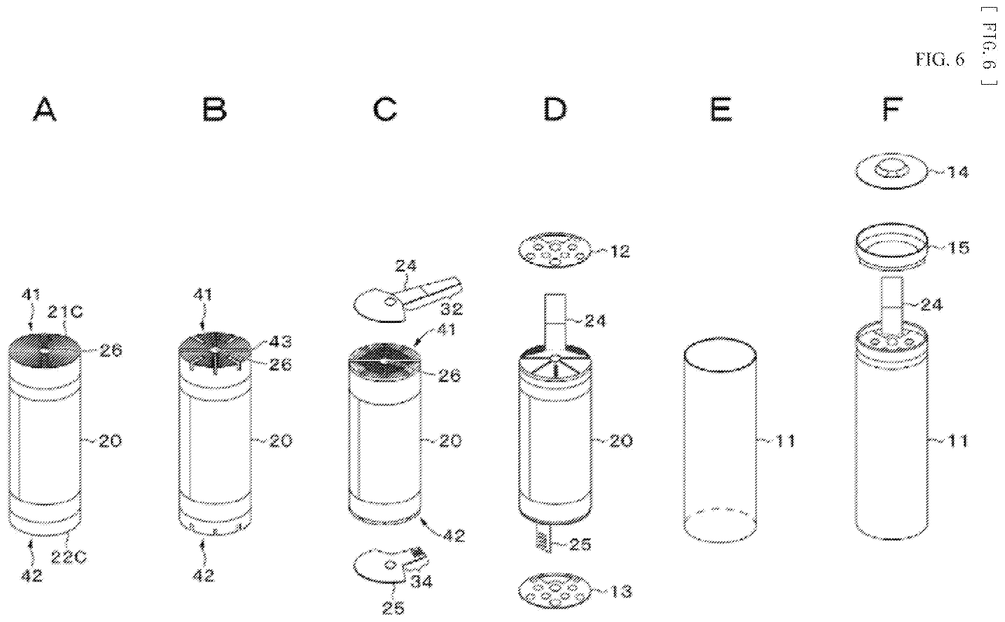

Next, a method of fabricating the lithium ion battery 1 according to an embodiment will be described with reference to FIGS. 6A to 6F. First, the positive electrode active material was applied on the surface of the positive electrode foil 21A having a band shape to thereby form the positive electrode active material covered part 21B, and the negative electrode active material was applied on the surface of the negative electrode foil 22A having a band shape to thereby form the negative electrode active material covered part 22B. At this time, the positive electrode active material uncovered part 21C without the positive electrode active material applied thereon was provided on one end side in the width direction of the positive electrode foil 21A, and the negative electrode foil 22A was provided with the negative electrode active material uncovered part 22C (including the first negative electrode active material uncovered part 221A, the second negative electrode active material uncovered part 221B, and the third negative electrode active material uncovered part 221C) without the negative electrode active material applied thereon. Further, when providing the negative electrode active material covered part 22B, the insulating resin part 22D was provided by applying a resin. Further, cutouts were formed in respective portions of the positive electrode active material uncovered part 21C and the negative electrode active material uncovered part 22C corresponding to the beginning of winding of the electrodes when wound. Thereafter, the positive electrode 21 and the negative electrode 22 were subjected to processes including a drying process. Thereafter, the positive electrode 21 and the negative electrode 22 were laid over each other with the separator 23 interposed therebetween in such a manner that the positive electrode active material uncovered part 21C and the negative electrode active material uncovered part 22C faced toward opposite directions, and they were wound in a spiral shape to allow the through hole 26 to develop on the central axis and to allow the cutouts having been formed to be located near the central axis. Thus, the electrode wound body 20 as illustrated in FIG. 6A was fabricated.

Next, as illustrated in FIG. 6B, grooves 43 were formed in respective portions of the end faces 41 and 42 by pressing an edge of a thin flat plate or the like (having a thickness of 0.5 mm, for example) perpendicularly against each of the end faces 41 and 42. By this method, the grooves 43 were formed to extend radially from the through hole 26. The number and arrangement of the grooves 43 illustrated in FIG. 6B are merely one example. Thereafter, as illustrated in FIG. 6C, the end faces 41 and 42 were made into flat surfaces by applying equal pressures to the end faces 41 and 42 simultaneously from both electrode sides in directions substantially perpendicular to the end faces 41 and 42 and thereby bending portions of the active material uncovered part 21C of the positive electrode and portions of the active material uncovered part 22C of the negative electrode. At this time, a load was applied using, for example, a plate surface of a flat plate or the like to cause portions of the active material uncovered part that are located at the end face 41 to be bent toward the central axis and overlap with each other, and to cause portions of the active material uncovered part that are located at the end face 42 to be bent toward the central axis and overlap with each other. Thereafter, the fan-shaped part 31 of the positive electrode current collector 24 was coupled to the end face 41 by laser welding, and the fan-shaped part 33 of the negative electrode current collector 25 was coupled to the end face 42 by laser welding.

Thereafter, as illustrated in FIG. 6D, the band-shaped part 32 of the positive electrode current collector 24 and the band-shaped part 34 of the negative electrode current collector 25 were bent, the insulator 12 was attached to the positive electrode current collector 24, and the insulator 13 was attached to the negative electrode current collector 25. The electrode wound body 20 having been assembled in the above-described manner was placed into the battery can 11 illustrated in FIG. 6E, and the bottom of the battery can 11 was welded. The electrolytic solution was injected into the battery can 11, following which the battery can 11 was sealed with the gasket 15 and the battery cover 14, as illustrated in FIG. 6F. The lithium ion battery 1 was fabricated as described above.

Note that the insulators 12 and 13 may each be an insulating tape. Further, a method of coupling may be other than laser welding. The grooves 43 remain in the flat surfaces even after the positive electrode active material uncovered part 21C and the negative electrode active material uncovered part 22C are bent, and a portion of each of the flat surfaces without the grooves 43 is coupled to the positive electrode current collector 24 or the negative electrode current collector 25; however, the grooves 43 may be coupled to a portion of the positive electrode current collector 24 or a portion of the negative electrode current collector 25.

As used herein, the term “flat surface” encompasses not only a completely flat surface but also a surface having some asperities or surface roughness to the extent that it is possible to couple the positive electrode active material uncovered part 21C and the positive electrode current collector 24 to each other and to couple a predetermined region of the negative electrode active material uncovered part 22C (e.g., the first negative electrode active material uncovered part 221A) and the negative electrode current collector 25 to each other.

The present embodiment makes it possible to achieve the following effects, for example.

In the present embodiment, the insulating resin part 22D is provided on the negative electrode foil 22A. Accordingly, the negative electrode active material covered part 22B and the insulating resin part 22D interact with each other, i.e., push against each other, which makes it possible to improve straightness, in the longitudinal direction, of a boundary (a boundary 22E in FIG. 5) between the negative electrode active material covered part 22B and the insulating resin part 22D.

As described above, it has been difficult to secure the straightness of the boundary 22E due to, for example, necking or unevenness at the boundary 22E. Accordingly, to cause the positive electrode active material covered part 21B and the negative electrode active material covered part 22B to be reliably opposed to each other, it has been necessary to set a distance D10 (see FIG. 5) from an end of the positive electrode active material covered part 21B to an end of the negative electrode active material covered part 22B to a large value to be on the safe side. This can make the positive electrode active material covered part 21B smaller in region, resulting in a decrease in battery capacity. However, the present embodiment makes it possible to improve the straightness of the boundary 22E, and accordingly, makes it possible to reduce the distance D10 as much as possible. This allows the positive electrode active material covered part 21B to be large in region, thereby making it possible to increase the battery capacity of the lithium ion battery 1.

During fabrication of the lithium ion battery, the negative electrode active material can sometimes peel off the negative electrode active material covered part 22B on the beginning side of the winding of the electrode wound body 20, i.e., an end side in the longitudinal direction of the positive electrode or the negative electrode located in an innermost wind of the electrode wound body 20, when the edge of the thin flat plate or the like (having a thickness of 0.5 mm, for example) is pressed perpendicularly against each of the end faces 41 and 42, that is, when the process illustrated in FIG. 6B is performed. A possible cause of the peeling is stress generated upon pressing the thin flat plate or the like against the end face 42. The negative electrode active material having peeled off can enter the inside of the electrode wound body 20 and can thereby cause an internal short circuit. According to the present embodiment, the provision of the second negative electrode active material uncovered part 221B and the third negative electrode active material uncovered part 221C helps to prevent the peeling of the negative electrode active material, thereby helping to prevent the occurrence of the internal short circuit. Such an effect is achievable even with a configuration in which only either the second negative electrode active material uncovered part 221B or the third negative electrode active material uncovered part 221C is provided; however, it is preferable that both be provided.

On an end side of winding of the electrode wound body 20, the negative electrode 22 may have a region of the negative electrode active material uncovered part 22C at a major surface facing away from the positive electrode active material covered part 21B. A reason for this is that even if the negative electrode active material covered part 22B is present at the major surface facing away from the positive electrode active material covered part 21B, its contribution to charging and discharging is considered to be low. The region of the negative electrode active material uncovered part 22C preferably falls within a range from ¾ winds to 5/4 winds, both inclusive, of the electrode wound body 20. In this case, owing to the absence of the negative electrode active material covered part 22B that is low in contribution to charging and discharging, it is possible to make an initial capacity higher with respect to the same volume of the electrode wound body 20.

According to the present embodiment, in the electrode wound body 20, the positive electrode 21 and the negative electrode 22 are laid over each other and wound in such a manner that the positive electrode active material uncovered part 21C and the negative electrode active material uncovered part 22C face toward opposite directions. Thus, the positive electrode active material uncovered part 21C is localized to the end face 41, and the negative electrode active material uncovered part 22C is localized to the end face 42. The positive electrode active material uncovered part 21C and the negative electrode active material uncovered part 22C are bent to make the end faces 41 and 42 into flat surfaces. The direction of bending is from an outer edge part 27 of the end face 41 toward the through hole 26 or from an outer edge part 28 of the end face 42 toward the through hole 26. Portions of the active material uncovered part that are located in adjacent winds in a wound state are bent and overlap with each other. By making the end face 41 into a flat surface, it is possible to achieve better contact between the positive electrode active material uncovered part 21C and the positive electrode current collector 24; and by making the end face 42 into a flat surface, it is possible to achieve better contact between the negative electrode active material uncovered part 22C and the negative electrode current collector 25. Further, the configuration in which the end faces 41 and 42 are made into flat surfaces by the bending makes it possible for the lithium ion battery 1 to achieve reduced resistance.

It may seem to be possible to make the end faces 41 and 42 into flat surfaces by bending the positive electrode active material uncovered part 21C and the negative electrode active material uncovered part 22C; however, without any processing in advance of bending, creases or voids (gaps or spaces) can develop in the end faces 41 and 42 upon bending, thus making it difficult for the end faces 41 and 42 to be flat surfaces. Here, “creases” and “voids” are unevenness that can develop in the positive electrode active material uncovered part 21C and the negative electrode active material uncovered part 22C having been bent, resulting in non-flat portions of the end faces 41 and 42. In the present embodiment, the grooves 43 are formed in advance in radial directions from the through hole 26 on each of the end face 41 side and the end face 42 side. The presence of the grooves 43 helps to prevent the creases and voids from developing, and thereby helps to achieve increased flatness of the end faces 41 and 42. Note that although either the positive electrode active material uncovered part 21C or the negative electrode active material uncovered part 22C may be bent, it is preferable that both be bent.

In the present embodiment, the cutout is provided in each of a portion of the positive electrode active material uncovered part 21C at the beginning of winding of the positive electrode 21 and a portion of the negative electrode active material uncovered part 22C at the beginning of winding of the negative electrode 22. This helps to prevent the through hole 26 from being blocked when the positive electrode active material uncovered part 21C and the negative electrode active material uncovered part 22C are bent toward the through hole 26.

### EXAMPLE

In the following, the present application will be described with reference to Example and comparative examples in which the lithium ion batteries 1 fabricated in the above-described manner were used to evaluate: incidence of internal short circuit resulting from peeling of the negative electrode active material; variation in length of the negative electrode active material covered part 22B in the width direction; length in the width direction of the positive electrode active material covered part 21B opposed to the negative electrode active material covered part 22B; and rated capacity of the lithium ion battery 1. Note that the present application is not limited to Example described herein.

In each of all the following Example and comparative examples, a battery size was set to 21700 (21 mm in diameter and 70 mm in height), the length of the negative electrode active material covered part 22B in the width direction was set to 62 mm, and a length of the separator 23 in the width direction was set to 64 mm. The separator 23 was placed to cover all of regions of the positive electrode active material covered part 21B and the negative electrode active material covered part 22B. The length of the positive electrode active material uncovered part 21C in the width direction was set to 7 mm. The number of the grooves 43 was set to eight, and the eight grooves were arranged at substantially equal angular intervals.

FIG. 4 and FIGS. 7 to 9 illustrate the respective negative electrodes 22 corresponding to Example 1 and Comparative examples 1 to 3.

### Example 1

The lithium ion battery 1 was fabricated through the above-described process. In fabricating the lithium ion battery 1, as illustrated in FIG. 4, the negative electrode active material covered part 22B and the negative electrode active material uncovered part 22C were provided at each of both surfaces of the negative electrode foil 22A, and the negative electrode foil 22A was cut at the negative electrode active material uncovered part 22C to thereby provide the first negative electrode active material uncovered part 221A, the second negative electrode active material uncovered part 221B, and the third negative electrode active material uncovered part 221C. Further, the insulating resin part 22D was provided between the negative electrode active material covered part 22B and the first negative electrode active material uncovered part 221A. A length of the insulating resin part 22D in the width direction was set to 3 (mm).

### Comparative Example 1

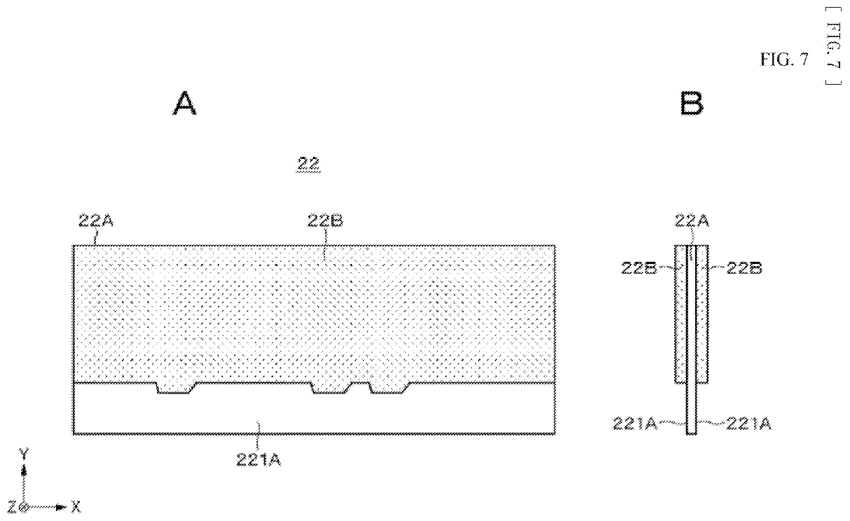

As illustrated in FIG. 7, the negative electrode active material covered part 22B and the first negative electrode active material uncovered part 221A were provided at each of both surfaces of the negative electrode foil 22A. None of the second negative electrode active material uncovered part 221B, the third negative electrode active material uncovered part 221C, and the insulating resin part 22D was provided. Except for the above differences, the lithium ion battery 1 was fabricated in a manner similar to that in Example 1.

### Comparative Example 2

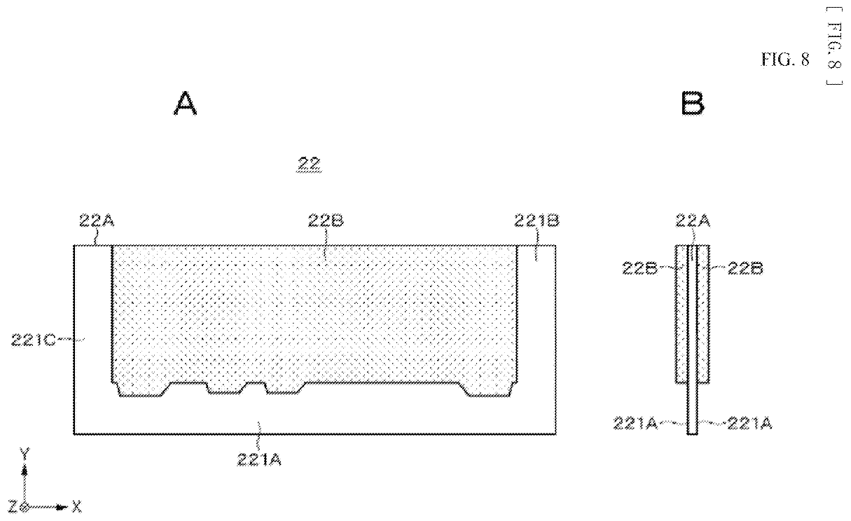

As illustrated in FIG. 8, both surfaces of the negative electrode foil 22A were each provided with the negative electrode active material covered part 22B and the negative electrode active material uncovered part 22C, and the negative electrode foil 22A was cut at the negative electrode active material uncovered part 22C to thereby provide the first negative electrode active material uncovered part 221A, the second negative electrode active material uncovered part 221B, and the third negative electrode active material uncovered part 221C. The insulating resin part 22D was not provided. Except for the above difference, the lithium ion battery 1 was fabricated in a manner similar to that in Example 1.

### Comparative Example 3

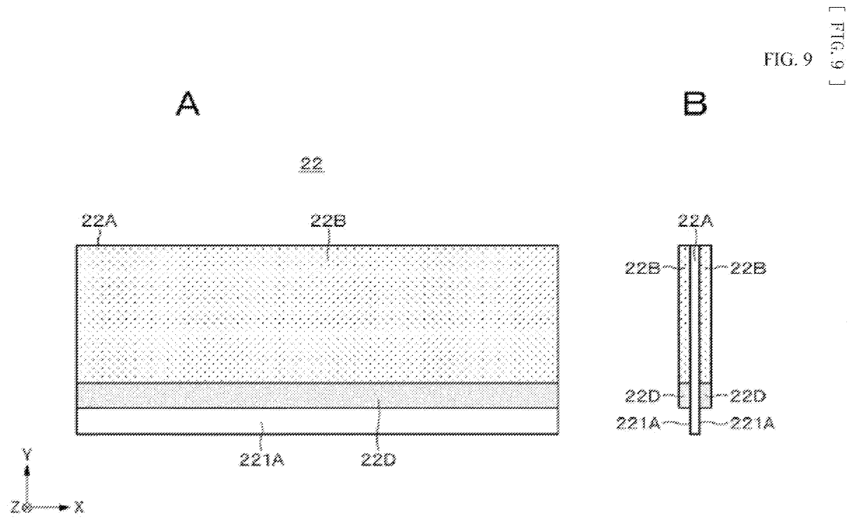

As illustrated in FIG. 9, both surfaces of the negative electrode foil 22A were each provided with the negative electrode active material covered part 22B, the first negative electrode active material uncovered part 221A, and the insulating resin part 22D. Neither of the second negative electrode active material uncovered part 221B and the third negative electrode active material uncovered part 221C was provided. Except for the above differences, the lithium ion battery 1 was fabricated in a manner similar to that in Example 1. The length of the insulating resin part 22D in the width direction was set to 3 (mm).

The lithium ion batteries 1 of the respective examples described above were assembled and charged to a voltage of 4.20 V, and were stored for five days in an environment at 25° C.±3° C. Thereafter, voltages of the lithium ion batteries 1 having been stored were measured. The number of the lithium ion batteries 1 with a voltage drop of 50 mV or more (i.e., with a voltage of 4.15 V or less) was counted, and a proportion of such lithium ion batteries 1 was determined as an incidence of internal short circuit.

Further, the rated capacities (mAh) of the lithium ion batteries 1 were measured.

The variation in length of the negative electrode active material covered part 22B in the width direction was calculated as follows. On one of the major surfaces of the negative electrode foil 22A, 200 measurement points were set for every 100-mm length from one side to another side in the longitudinal direction, and the length of the negative electrode active material covered part 22B in the width direction was determined at each of the measurement points to thereby calculate a variation σ based on the results thereof. Here, σ stands for a standard deviation.

The length of the positive electrode active material covered part 21B in the width direction was set to a width of the positive electrode active material covered part allowing for keeping the following relationship: width of negative electrode active material covered part>width of positive electrode active material covered part, after confirmation of the variation σ of the negative electrode active material covered part 22B.

A hundred lithium ion batteries 1 were fabricated for each of respective configurations of Example 1 and Comparative examples 1 to 3, and were subjected to evaluation. The results are given in Table 1 below.

TABLE 1

| | | | Evaluation | | | |
|---|---|---|---|---|---|---|
| | | | Incidence [%] of internal | | | |
| | | | short circuit resulting from | Variation [σ] in width | Width dimension [mm] | |
| | | End part in | peeling of active material | dimension of negative | of opposed positive | |
| | Corresponding | longitudinal | at end part in longitudinal | electrode active | electrode active | Rated capacity |
| | figure | direction | direction | material covered part | material covered part | [mAh] |
| Example 1 | FIG. 4 | Cut at negative | 0 | 0.07 | 59.4 | 3825 |
| | | electrode active | | | | |
| | | material uncovered | | | | |
| | | part | | | | |
| Comparative example 1 | FIG. 7 | Cut along straight | 6 | 0.21 | 59 | 3800 |
| | | line including | | | | |
| | | negative electrode | | | | |
| | | active material | | | | |
| | | covered part | | | | |
| Comparative example 2 | FIG. 8 | Cut at negative | 0 | 0.19 | 59 | 3800 |
| | | electrode active | | | | |
| | | material uncovered | | | | |
| | | part | | | | |
| Comparative example 3 | FIG. 9 | Cut along straight | 4 | 0.07 | 59.4 | 3825 |
| | | line including | | | | |
| | | negative electrode | | | | |
| | | active material | | | | |
| | | covered part | | | | |

In Example 1 and Comparative example 3, the variation σ in width dimension of the negative electrode active material covered part 22B was 0.07, whereas in Comparative examples 1 and 2, the variation σ in width dimension of the negative electrode active material covered part 22B was as large as 0.19 to 0.21. A possible reason for the smaller variation σ in Example 1 and Comparative example 3 is that, owing to the provision of the insulating resin part 22D, the negative electrode active material covered part 22B and the insulating resin part 22D interacted with each other to improve the straightness of the end part of the negative electrode active material covered part 22B. Further, in Example 1 and Comparative example 3, the smaller variation σ allowed for an increase in the length of the positive electrode active material covered part 21B in the width direction by 0.4 mm relative to that in Comparative examples 1 and 2, resulting in an increase in the battery capacity by 25 mAh.

In Example 1 and Comparative example 2, the incidence of internal short circuit was 0%, whereas in Comparative examples 1 and 3, the incidence of internal short circuit was as high as 4% to 6%. A possible reason for this is that in the lithium ion batteries 1 of Comparative examples 1 and 3, due to the absence of the second negative electrode active material uncovered part 221B and the third negative electrode active material uncovered part 221C at the respective end parts of the negative electrode foil 22A on the beginning side of the winding and the end side of the winding, peeling and falling-off of the negative electrode active material occurred at the position where the negative electrode foil 22A was cut, and the negative electrode active material having fallen off entered the inside of the electrode wound body 20 to cause an internal short circuit. In contrast, in Example 1 and Comparative example 2 each provided with the second negative electrode active material uncovered part 221B and the third negative electrode active material uncovered part 221C, no peeling or falling-off of the negative electrode active material occurred, and accordingly, no internal short circuit occurred.

Based upon the above, the configuration corresponding to Example 1 is considered to be a preferable configuration of the lithium ion battery 1.

Although one or more embodiments of the present application have been described herein, the contents of the present application are not limited thereto, and various suitable modifications may be made in relation to the present application.

Although the number of the grooves 43 is eight in Example and the comparative examples, any other number may be chosen. Although the battery size chosen is 21700 (21 mm in diameter and 70 mm in height), the battery size may be 18650 (18 mm in diameter and 65 mm in height) or any other size.

Although the positive electrode current collector 24 and the negative electrode current collector 25 respectively include the fan-shaped parts 31 and 33 each having a fan shape, any other shape may be chosen.

The present application is applicable to any battery other than the lithium ion battery, and to any battery having a shape other than the cylindrical shape, such as a laminated battery, a prismatic battery, a coin-type battery, or a button-type battery, without departing from the scope of the present application. In such a case, the shape of the “end face of the electrode wound body” is not limited to a circular shape, and may be any of other shapes including, without limitation, an elliptical shape and an elongated shape.

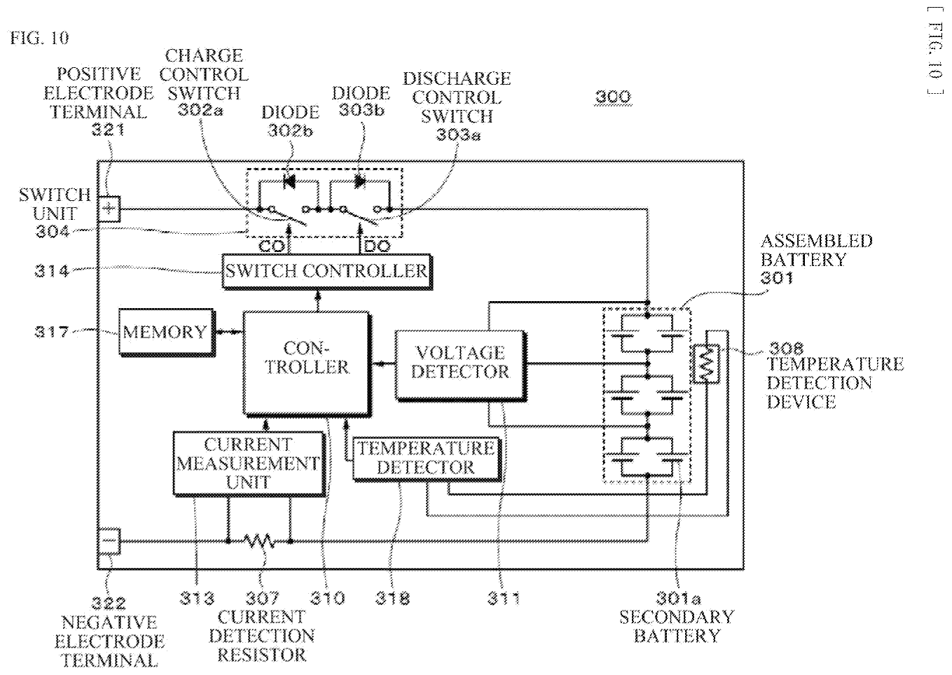

FIG. 10 is a block diagram illustrating a circuit configuration example where the secondary battery according to an embodiment is applied to a battery pack 300. The battery pack 300 includes an assembled battery 301, a switch unit 304, a current detection resistor 307, a temperature detection device 308, and a controller 310. The switch unit 304 includes a charge control switch 302a and a discharge control switch 303a. The controller 310 controls each device. Further, the controller 310 is able to perform charge and discharge control upon abnormal heat generation, and to perform calculation and correction of a remaining capacity of the battery pack 300. The battery pack 300 includes a positive electrode terminal 321 and a negative electrode terminal 322 that are couplable to a charger or electronic equipment for charging and discharging.

The assembled battery 301 includes multiple secondary batteries 301a coupled in series or in parallel. FIG. 10 illustrates an example case in which six secondary batteries 301a are coupled in a two parallel coupling and three series coupling (2P3S) configuration. The secondary battery is applicable to the secondary battery 301a.

A temperature detector 318 is coupled to the temperature detection device 308 (for example, a thermistor). The temperature detector 318 measures a temperature of the assembled battery 301 or the battery pack 300, and supplies the measured temperature to the controller 310. A voltage detector 311 measures a voltage of the assembled battery 301 and a voltage of each of the secondary batteries 301a included therein, performs A/D conversion on the measured voltages, and supplies the converted voltages to the controller 310. A current measurement unit 313 measures currents using the current detection resistor 307, and supplies the measured currents to the controller 310.

A switch controller 314 controls the charge control switch 302a and the discharge control switch 303a of the switch unit 304 based on the voltages and the currents respectively supplied from the voltage detector 311 and the current measurement unit 313. When the voltage of any of the secondary batteries 301a becomes higher than or equal to an overcharge detection voltage or becomes lower than or equal to an overdischarge detection voltage, the switch controller 314 transmits a turn-off control signal to the switch unit 304 to thereby prevent overcharging or overdischarging. The overcharge detection voltage is, for example, 4.20 V±0.05 V. The overdischarge detection voltage is, for example, 2.4 V±0.1 V.

After the charge control switch 302a or the discharge control switch 303a is turned off, charging or discharging is enabled only through a diode 302b or a diode 303b. Semiconductor switches such as MOSFETs are employable as these charge and discharge control switches. Note that although the switch unit 304 is provided on a positive side in FIG. 10, the switch unit 304 may be provided on a negative side.

A memory 317 includes a RAM and a ROM. Numerical values including, for example, battery characteristic values, a full charge capacity, and a remaining capacity calculated by the controller 310 are stored and rewritten therein.

The secondary battery according to an embodiment described herein is mountable on equipment such as electronic equipment, electric transport equipment, or a power storage apparatus, and is usable to supply electric power.

Examples of the electronic equipment include laptop personal computers, smartphones, tablet terminals, personal digital assistants (PDAs) (mobile information terminals), mobile phones, wearable terminals, digital still cameras, electronic books, music players, game machines, hearing aids, electric tools, televisions, lighting equipment, toys, medical equipment, and robots. In addition, electric transport equipment, power storage apparatuses, and electric unmanned aerial vehicles, which will be described later, may also be included in the electronic equipment in a broad sense.

Examples of the electric transport equipment include electric automobiles (including hybrid electric automobiles), electric motorcycles, electric-assisted bicycles, electric buses, electric carts, automated guided vehicles (AGVs), and railway vehicles. Examples of the electric transport equipment further include electric passenger aircrafts and electric unmanned aerial vehicles for transportation. The secondary battery according to an embodiment is used not only as a driving power source for the foregoing electric transport equipment but also as, for example, an auxiliary power source or an energy-regenerative power source therefor.

Examples of the power storage apparatuses include a power storage module for commercial or household use, and a power storage power source for architectural structures including residential houses, buildings, and offices, or for power generation facilities.

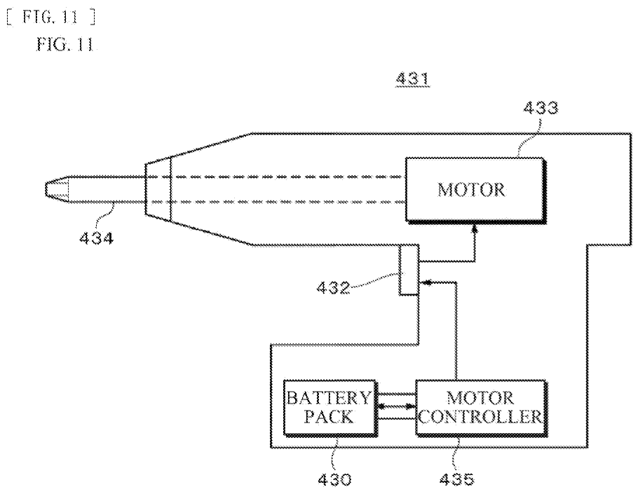

As an example of the electric tools to which the present application is applicable, an electric screwdriver will be schematically described with reference to FIG. 11. An electric screwdriver 431 includes a motor 433 and a trigger switch 432. The motor 433 transmits rotational power to a shaft 434. The trigger switch 432 is operated by a user. A battery pack 430 and a motor controller 435 are contained in a lower housing of a handle of the electric screwdriver 431. The battery pack 430 is built in or detachably attached to the electric screwdriver 431. The secondary battery according to an embodiment is applicable to a battery included in the battery pack 430.

The battery pack 430 and the motor controller 435 may include respective microcomputers (not illustrated) communicable with each other to transmit and receive charge and discharge data on the battery pack 430. The motor controller 435 controls operation of the motor 433, and is able to cut off power supply to the motor 433 under abnormal conditions such as overdischarging.

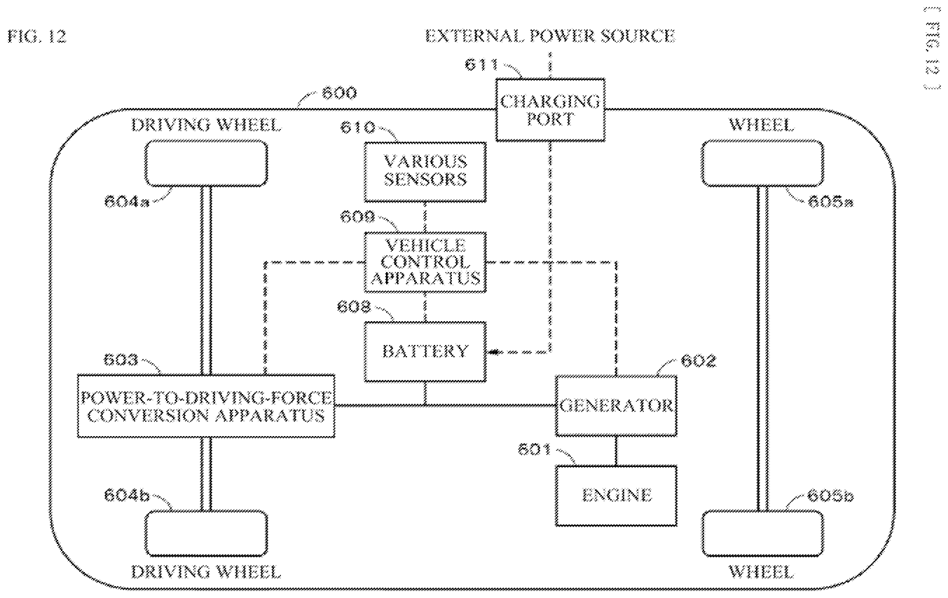

As an example of application of the present application to a power storage system for electric vehicles, FIG. 12 schematically illustrates a configuration example of a hybrid vehicle (HV) that employs a series hybrid system. The series hybrid system relates to a vehicle that travels with an electric-power-to-driving-force conversion apparatus, using electric power generated by a generator that uses an engine as a power source, or using electric power temporarily stored in a battery.

A hybrid vehicle 600 is equipped with an engine 601, a generator 602, an electric-power-to-driving-force conversion apparatus (a direct-current motor or an alternating-current motor; hereinafter, simply “motor 603”), a driving wheel 604a, a driving wheel 604b, a wheel 605a, a wheel 605b, a battery 608, a vehicle control apparatus 609, various sensors 610, and a charging port 611. The secondary battery according to an embodiment, or a power storage module equipped with a plurality of secondary batteries according to an embodiment is applicable to the battery 608.

The motor 603 operates under the electric power of the battery 608, and a rotational force of the motor 603 is transmitted to the driving wheels 604a and 604b. Electric power generated by the generator 602 using a rotational force generated by the engine 601 is storable in the battery 608. The various sensors 610 control an engine speed via the vehicle control apparatus 609, and control an opening angle of an unillustrated throttle valve.

When the hybrid vehicle 600 is decelerated by an unillustrated brake mechanism, a resistance force at the time of deceleration is applied to the motor 603 as a rotational force, and regenerative electric power generated from the rotational force is stored in the battery 608. In addition, the battery 608 is chargeable by being coupled to an external power source via the charging port 611 of the hybrid vehicle 600. Such an HV vehicle is referred to as a plug-in hybrid vehicle (PHV or PHEV).

Note that the secondary battery according to an embodiment of the present application may be applied to a small-sized primary battery and used as a power source of an air pressure sensor system (a tire pressure monitoring system: TPMS) built in the wheels 604 and 605.

Although the series hybrid vehicle has been described above as an example, the present application is applicable also to a hybrid vehicle of a parallel system in which an engine and a motor are used in combination, or of a combination of the series system and the parallel system. Furthermore, the present application is applicable to an electric vehicle (EV or BEV) and a fuel cell vehicle (FCV) that travel by means of only a driving motor without using an engine.

### REFERENCE SIGNS LIST

1: lithium ion battery
12: insulator
21: positive electrode
21A: positive electrode foil
21B: positive electrode active material layer
21C: positive electrode active material uncovered part
22: negative electrode
22A: negative electrode foil
22B: negative electrode active material layer
22C: negative electrode active material uncovered part
23: separator
22D: insulating resin part
24: positive electrode current collector
25: negative electrode current collector
26: through hole
27, 28: outer edge part
41, 42: end face
43: groove
221A: first negative electrode active material uncovered part
221B: second negative electrode active material uncovered part
221C: third negative electrode active material uncovered part

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
an electrode wound body including a positive electrode having a band shape and a negative electrode having a band shape, the positive electrode and the negative electrode being stacked with a separator interposed therebetween;
a positive electrode current collector;
a negative electrode current collector; and
a battery can containing the electrode wound body, the positive electrode current collector, and the negative electrode current collector, wherein
the positive electrode includes, on a positive electrode foil having a band shape, a positive electrode active material covered part covered with a positive electrode active material layer, and a positive electrode active material uncovered part,
the negative electrode includes, on a negative electrode foil having a band shape, a negative electrode active material covered part covered with a negative electrode active material layer, a first negative electrode active material uncovered part extending in a longitudinal direction of the negative electrode foil, a second negative electrode active material uncovered part provided at an end part in the longitudinal direction on a beginning side of winding, and an insulating resin part provided between the negative electrode active material covered part and the first negative electrode active material uncovered part,
the positive electrode active material uncovered part is coupled to the positive electrode current collector at one of end parts of the electrode wound body,
the first negative electrode active material uncovered part is coupled to the negative electrode current collector at another of the end parts of the electrode wound body, and
the electrode wound body has one or more flat surfaces, in which the positive electrode active material uncovered part, the first negative electrode active material uncovered part, or both are bent toward a central axis of the wound structure to form the one or more flat surfaces, and a groove provided in each of the one or more flat surfaces.

2. The secondary battery according to claim 1, wherein the negative electrode further includes a third negative electrode active material uncovered part at an end part in the longitudinal direction on an end side of the winding.

3. The secondary battery according to claim 1, wherein the insulating resin part has a thickness smaller than or equal to a thickness of the negative electrode active material covered part.

4. Electronic equipment comprising the secondary battery according to claim 1.

5. An electric tool comprising the secondary battery according to claim 1.
